(19) United States
(12) Patent Application Publication
(10) Pub. No.: US 2015/0104695 A1
(43) Pub. Date: Apr. 16, 2015

(54) FOLDED LITHIUM-ION CELL STACK

(71) Applicant: Lenovo (Singapore) Pte. Ltd., Singapore (SG)

(72) Inventors: Bouziane YEBKA, Apex, NC (US); Joseph Anthony HOLUNG, Wake Forest, NC (US); Tin-Lup WONG, Chapel Hill, NC (US); Philip John JAKES, Durham, NC (US)

(73) Assignee: Lenovo (Singapore) Pte. Ltd., Singapore (SG)

(21) Appl. No.: 14/053,365

(22) Filed: Oct. 14, 2013

(51) Int. Cl. H01M 10/04; H01M 10/0525

(52) U.S. Cl. CPC H01M 10/0431; H01M 10/0525
USPC 429/163; 429/233; 29/623.1

(57) ABSTRACT

A lithium-ion battery can include anode electrode material; anode collector material; cathode electrode material; cathode collector material; a full electrode that includes a layer of one of the collector materials disposed between and adjacent to two layers of a corresponding one of the electrode materials; a half electrode that includes a layer of one of the collector materials disposed adjacent to a layer of a corresponding one of the electrode materials; and lithium-ion conductive separator material folded to align the full electrode and the half electrode and disposed between one of the two layers of the electrode material of the full electrode and the layer of the electrode material of the half electrode. Various other apparatuses, systems, methods, etc., are also disclosed.

### TECHNICAL FIELD

Subject matter disclosed herein generally relates to lithium-ion cell technologies.

### BACKGROUND

Electrochemical cells include, for example, lithium-ion cells. Such cells may be characterized, for example, as to specific energy (e.g., Wh/kg or MJ/kg), energy density (Wh/l or MJ/l), specific power (W/kg), etc. Various technologies and techniques described herein pertain to electrochemical cells, for example, including lithium-ion cells.

### SUMMARY

A lithium-ion battery can include anode electrode material; anode collector material; cathode electrode material; cathode collector material; a full electrode that includes a layer of one of the collector materials disposed between and adjacent to two layers of a corresponding one of the electrode materials; a half electrode that includes a layer of one of the collector materials disposed adjacent to a layer of a corresponding one of the electrode materials; and lithium-ion conductive separator material folded to align the full electrode and the half electrode and disposed between one of the two layers of the electrode material of the full electrode and the layer of the electrode material of the half electrode. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of a battery and an example of a plot of relative energy density versus cell thickness;

FIG. 2 is a diagram of examples of stacks and an example of a plot related to energy;

FIG. 3 is a diagram of an example of a lithium-ion cell and examples of stacks;

FIG. 4 is a diagram of examples of stacks;

FIG. 5 is a diagram of an example of a stack;

FIG. 6 is a diagram of an example of a stack;

FIG. 7 is a diagram of an example of a stack;

FIG. 8 is a diagram of an example of a stack;

FIG. 9 is a diagram of an example of circuitry and an example of a method;

FIG. 10 is a diagram of examples of devices; and

FIG. 11 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

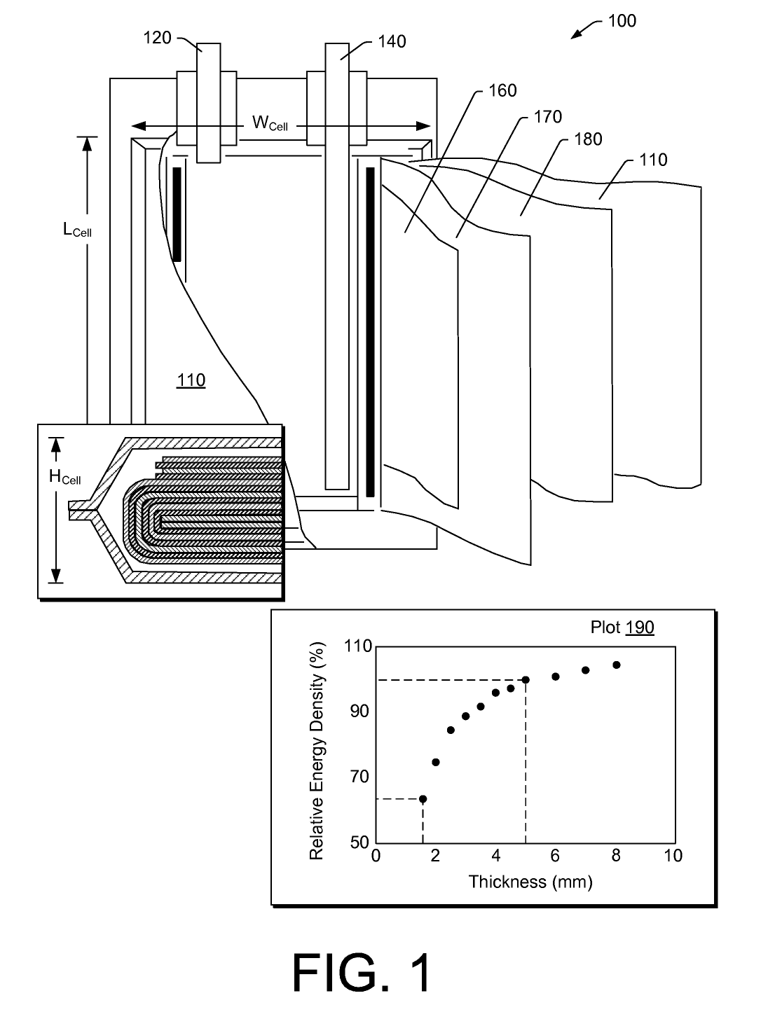

FIG. 1 shows an approximate cut-away view of an example of a battery 100 that includes a casing 110 and a positive tab 120 and a negative tab 140, for example, to operatively couple the battery 100 to circuitry. The casing 110 may include a cell region defined by a cell length (L_{Cell}), a cell width (W_{Cell}) and a cell height (H_{Cell}). As an example, the cell region may include one or more electrochemical cells. As an example, an electrochemical cell may be formed in part by a cathode 160, a separator 170 and an anode 180. Such components may be “folded”, for example, to form a stack (e.g., “jelly roll”) that may be housed in the cell region of the casing 110. As shown in the example of FIG. 1, in an approximate cross-sectional view, the height (H_{Cell}) of the cell region of the casing 110 may be defined in part by thicknesses of the cathode 160, the separator 170 and the anode 180 as well as, for example, by stacking of such components (e.g., winding in a roll or other configuration). As an example, a cathode formed of electrode material, an anode formed of electrode material and a separator formed of separator material along with collector materials may be layered and stacked, for example, by folding in a zigzag orientation, folding in a clockwise roll orientation, folding in a counterclockwise roll orientation, etc.

As mentioned, a cell (e.g., or cells) may be characterized, for example, as to specific energy (e.g., Wh/kg or MJ/kg), energy density (Wh/l or MJ/l), specific power (W/kg), etc. As an example, a region of a battery with one or more cells may include L_{Cell} and W_{Cell} dimensions (e.g., rectangular dimensions), for example, with a L_{Cell}/W_{Cell} ratio in a range of about 1 to about 5. As an example, consider a cell (or cells) with dimensions of about 120 mm (L_{Cell}) by about 100 mm (W_{Cell}) where, in combination with a height (H_{Cell}), a volume (Vol_{Cell}) may be calculated. As an example, with a volume (Vol_{Cell}) and energy density (ED in Wh/l), an energy value (e.g., Wh) may be determined for the battery.

FIG. 1 shows an example of a plot 190 that illustrates a relationship between cell(s) thickness (e.g., ˜H_{Cell}) and relative energy density. In the plot 190, a cell(s) thickness of about 5 mm may be used as a standard by which thinner or thicker cell(s) thicknesses may be compared. As indicated in the plot 190, for a cell(s) thickness greater than about 5 mm, the relative energy density may increase; however, for a cell(s) thickness less than about 5 mm, the relative energy density may decrease. For example, for a cells thickness of about 1.8 mm, the relative energy density may be about 65% of the relative energy density for a cells thickness of about 5 mm.

As an example, a battery with a volume of about 43 ml (˜43,000 cubic mm) and a thickness (H_{Cell}) of about 3.6 mm (e.g., with L_{Cell} and W_{Cell} of about 120 mm and about 100 mm) may have an energy density of about 480 Wh/l. In terms of energy, such a battery may be capable of storing about 21 Wh, which may be sufficient to power 2.6 W circuitry for about 8 hours (e.g., circuitry operational time). In such an example, where the circuitry and battery are housed in a housing (e.g., a device housing), the thickness of the housing may be expected to be greater than about 3.6 mm. As an example, consider an effort to make the same device with a battery having a thickness (H_{Cell}) of about 2 mm. In such an example, the energy density of the battery may be considerably less (see, e.g., the plot 190), which would result in less operational time, for example, perhaps about 6 hours versus about 8 hours (e.g., considering that the battery volume may be maintained).

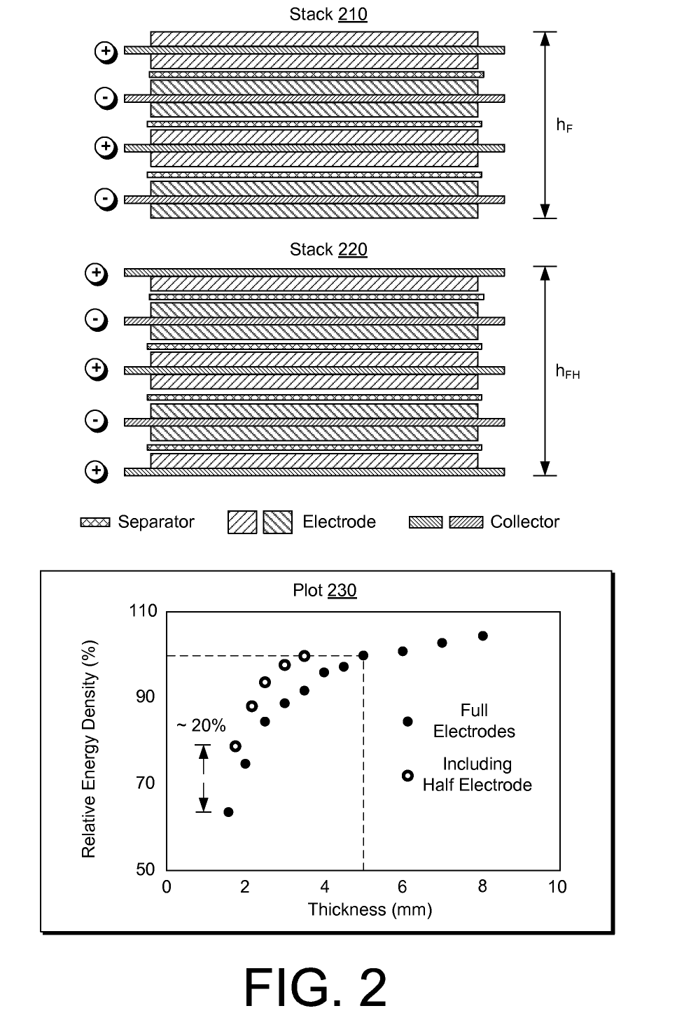

FIG. 2 shows example stacks 210 and 220 and a plot 230. As shown, the stack 210 includes layers of current collector material labeled as being positive or negative where each layer of current collector material has an associated upper layer and an associated lower layer of electrode material (e.g., anode electrode material or cathode electrode material). In such an example, a full electrode (e.g., a full anode electrode or a full cathode electrode) may be defined by a layer of current collector material having an associated upper layer and an associated lower layer of electrode material. Accordingly, the stack 210 includes four full electrodes where adjacent full electrodes are separated by separator material (e.g., three layers of separator material).

As an example, the energy density of the stack 210 may be defined in part by a height “h_{F}” and, for example, a number of cells, which may be determined based on the number of layers of separator materials that are disposed between different electrode materials. In such an example, the stack 210 may be defined as having an energy density defined in part by 3/h_{F} (e.g., number of cells per unit height).

As to the example stack 220, it includes two half electrodes, which may be defined by a layer of current collector material and an associated upper layer or an associated lower layer of electrode material. Accordingly, the stack 220 includes three full electrodes and two half electrodes where the electrodes are separated by separator material (e.g., four layers of separator material).

As an example, the energy density of the stack 220 may be defined in part by a height “h_{FH}” and, for example, a number of cells, which may be determined based on the number of layers of separator materials that are disposed between different electrode materials. In such an example, the stack 220 may be defined as having an energy density defined in part by 4/h_{FH} (e.g., number of cells per unit height).

As shown in FIG. 2, the height h_{FH} may be greater than the height h_{F}, however, the greater height may provide for an additional cell and, accordingly, a greater energy density.

The plot 230 shows that presence of one or more half electrodes may help to offset the impact of a decrease in cells thickness (see also the plot 190 of FIG. 1) with respect to energy density. For example, where h_{F} is approximately 1.8 mm and where h_{FH} is approximately 2 mm, the stack 210 may have an energy density defined in part by 3 cells/1.8 mm (˜1.67) and the stack 220 may have an energy density defined in part by 4 cells/2 mm (˜2.0). Accordingly, the energy density (ED) of the stack 220 may be about 20% greater than that of the stack 210 (e.g., 100(2.0−1.67)/1.67).

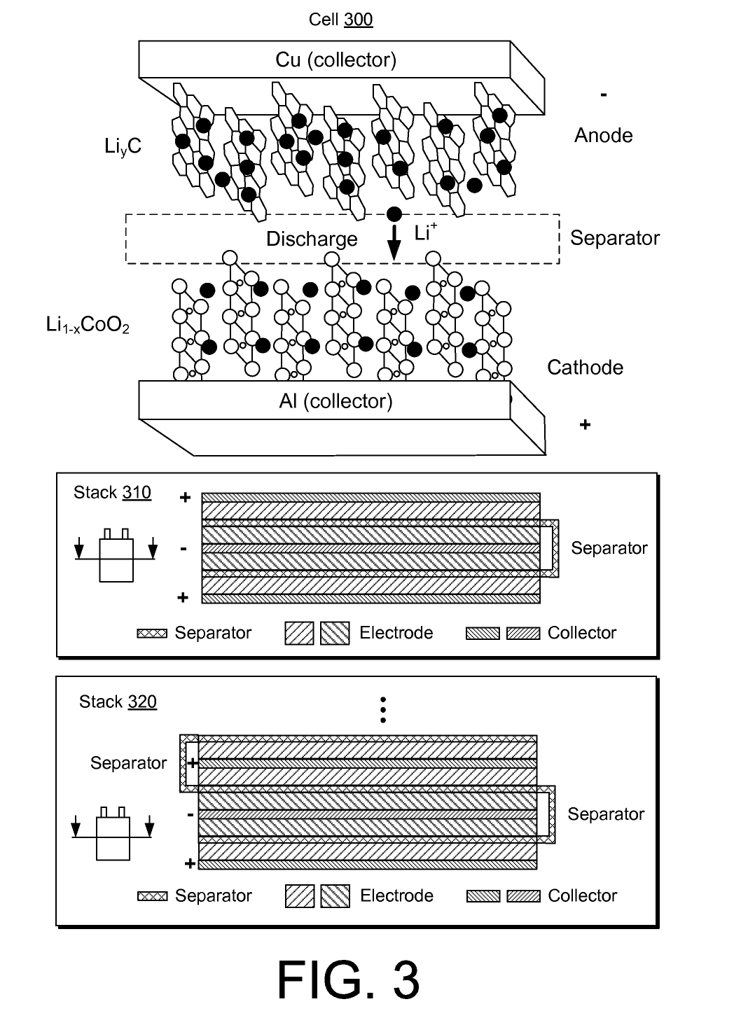

FIG. 3 shows an example of a cell 300 and examples of stacks of cells 310 and 320. As shown, the cell 300 includes an anode collector material that includes, for example, copper; an anode electrode material that includes lithium and carbon (e.g., Li_{y}C); a separator material configured for passage of lithium ions (e.g., in electrolyte); a cathode electrode material that includes lithium and metal oxide (e.g., Li₁₋ₓCoO₂); and a cathode collector material that includes, for example, aluminum. While carbon, cobalt, copper and aluminum are mentioned, other materials may be employed to form a lithium-ion cell.

As to the terms “anode” and “cathode”, these may be defined based on discharge, for example, where lithium ions migrate in a direction shown in FIG. 3 from a carbon-based matrix towards a metal oxide-based matrix. In other words, when a lithium-ion based cell is discharging, a positively charged lithium ion may be extracted from anode electrode material (e.g., graphite lattice) and inserted into cathode electrode material (e.g., into a lithium containing compound); whereas, when such a cell is charging, the reverse process may occur.

As an example, positive electrode material (e.g., cathode electrode material) may include LiCoO₂, LiMn₂O₄ or other compound. As an example, separator material may include a conducting polymer electrolyte (e.g. polyethyleneoxide “PEO”, etc.). For example, a separator material may include polymer that provides for conduction of lithium ions (e.g., a lithium-ion conductive polymer material). As an example, negative electrode material (e.g., anode electrode material) may include ionizable lithium metal, a carbon-lithium intercalation compound, etc.

As an example, a lithium-ion battery may include one or more cells where each cell includes an anode, a cathode and electrolyte, which may be a polymeric material or provided in a polymeric matrix. As an example, a cell may include an anode electrode material that includes carbon, a cathode electrode material that includes a metal oxide, and a separator material that includes polymer.

As an example, active electrode particles may be for a cathode to form cathode electrode material. For example, consider particles that include one or more of lithium cobalt oxide (LiCoO₂), lithium nickel oxide (LiNiO₂), lithium manganese oxide (LiMn₂O₄), and lithium iron phosphate (LiFePO₄).

As an example, positive active electrode particles may include lithium and metal oxide, for example, represented by LiₓM¹_{y}M²_{1-y}O₂ where 0.4≦x≦1; 0.3≦y≦1; M¹ is at least one selected from the group consisting of Ni and Mn; and M² is at least one selected from the group consisting of Co, Al, and Fe. As an example, positive active electrode particles may include lithium and metal oxide, for example, be represented by one of the following: LiNiₓCo_{y}Al_{z}O₂, where 0.7≦x≦1; 0≦y≦0.3; 0≦z≦0.03; and 0.9≦x+y+z≦1.1; LiNiₓCo_{y}Mn_{z}O₂, where 0.3≦x≦0.6; 0≦y≦0.4; 0.3≦z≦0.6; and 0.9≦x+y+z≦1.1; LiₓMn_{z}O₂, where 0.4≦x≦0.6; and 0.9≦z≦1; or LiFeₓCo_{y}Mn_{z}O₂, where 0.3≦x≦0.6; 0.1≦y≦0.4; 0.3≦z≦0.6; and 0.9≦x+y+z≦1.1.

As an example, active electrode particles may be for an anode to form anode electrode material. For example, consider particles that include one or more of carbon lithium and lithium titanate. As to lithium titanate, consider, for example: Li₂TiO₃; Li₄TiO₁₂; Li₄Ti₅O₁₂.

As an example, a cell may include electrolyte in a polymeric matrix. For example, consider an electrolyte that includes Li(ClO₄)₂ in polycarbonate/tetrahydrofuran (PC/THF) (e.g., about 0.4 M) or other polymeric matrix.

As an example, a lithium-ion battery can include anode electrode material; anode collector material; cathode electrode material; cathode collector material; a full electrode that includes a layer of one of the collector materials disposed between and adjacent to two layers of a corresponding one of the electrode materials; a half electrode that includes a layer of one of the collector materials disposed adjacent to a layer of a corresponding one of the electrode materials; and lithium-ion conductive separator material folded to align the full electrode and the half electrode and disposed between one of the two layers of the electrode material of the full electrode and the layer of the electrode material of the half electrode.

In FIG. 3, the stack 310 includes a full electrode and two half electrodes where separator material is folded, for example, to align the full electrodes and the half electrodes (e.g., aligned in a rectangular, folded stack). As shown in the example stack 310, the separator material is disposed between a layer of electrode material of the full electrode and a layer of electrode material of an upper half electrode and is also disposed between another layer of electrode material of the full electrode and a layer of electrode material of a lower half electrode. In the example stack 310, outer layers are formed by collector material (e.g., an upper outer layer and a lower outer layer).

As an example, the stack 310 may be included in a foil package (see, e.g., the casing 110 of FIG. 1), for example, with exposed contacts that operatively couple to collector materials (see, e.g., the tabs 120 and 140 of FIG. 1). In the example stack 310, the various layers perform battery-related functions. The example stack 310 may be defined as including two cells, for example, with three layers of collector material (e.g., two positive and one negative or two negative and one positive).

In FIG. 3, the example stack 320 includes at least two full electrodes and at least one half electrode, for example, where separator material is folded, for example, to align the full electrodes and the half electrodes.

As an example, a lithium-ion battery may include lithium-ion conductive separator material that is folded to form a stack (e.g., a cell stack). In such an example, a folded stack may be formed as a rectangular roll having a clockwise orientation or a counterclockwise orientation or, for example, a folded stack may be formed as a rectangular accordion stack having a zigzag orientation.

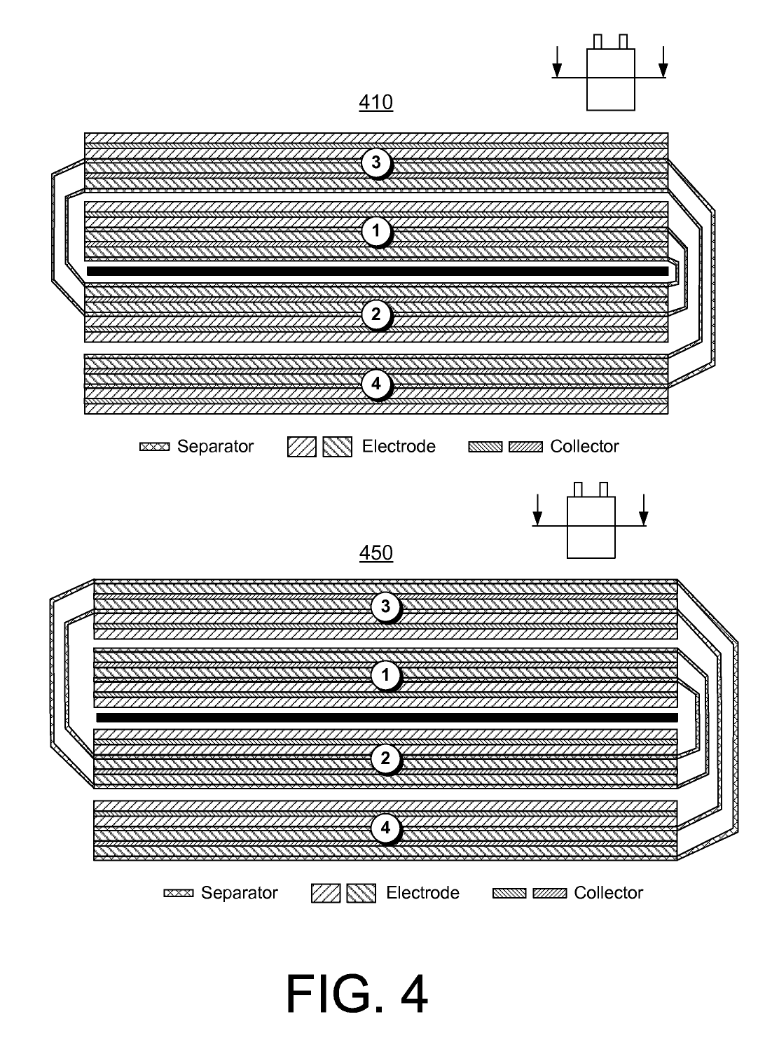

FIG. 4 shows two examples of folded stacks 410 and 450 formed, in part, by rolling material. In FIG. 4, for sake of simplicity, only layers of separator material are illustrated as to ends of the folded stacks 410 and 450; noting that all layers of a layered material may form ends of the folds.

As shown in FIG. 4, the folded stack 410 is formed by folding clockwise (e.g., rolling or winding clockwise) layered material that includes two full electrodes layers and two layers of separator material. Numerals 1, 2, 3 and 4 indicate relatively flat portions (e.g., rectangular portions) formed by the layered material. In such an example, a layer of material is disposed between portions 1 and 2, for example, as a core layer that hinders contact between two like layers. For the folded stack 410, the like layers adjacent to the core layer are separator material layers associated with like full electrodes.

As shown in FIG. 4, the folded stack 450 is formed by folding clockwise (e.g., rolling or winding clockwise) layered material that includes two full electrodes layers and two layers of separator material. The difference between the folded stacks 410 and 450 may be appreciated by considering how the layered material is oriented prior to rolling (e.g., which layer faces down and which layer faces up). Numerals 1, 2, 3 and 4 indicate relatively flat portions (e.g., rectangular portions) formed by the layered material. In such an example, a layer of material is disposed between portions 1 and 2, for example, as a core layer that hinders contact between two like layers. For the folded stack 450, the like layers adjacent to the core layer are like full electrodes (e.g., both cathodes or both anodes).

The folded stacks 410 and 450 include layers that contribute to thickness without contributing to energy. In other words, the folded stacks 410 and 450 include certain layers that can act to decrease energy density. For example, the folded stacks 410 and 450 include core layers that may be inactive or that may otherwise not contribute directly to energy. Further, the folded stacks 410 and 450 include outer layers that may be inactive or that may otherwise not contribute directly to energy.

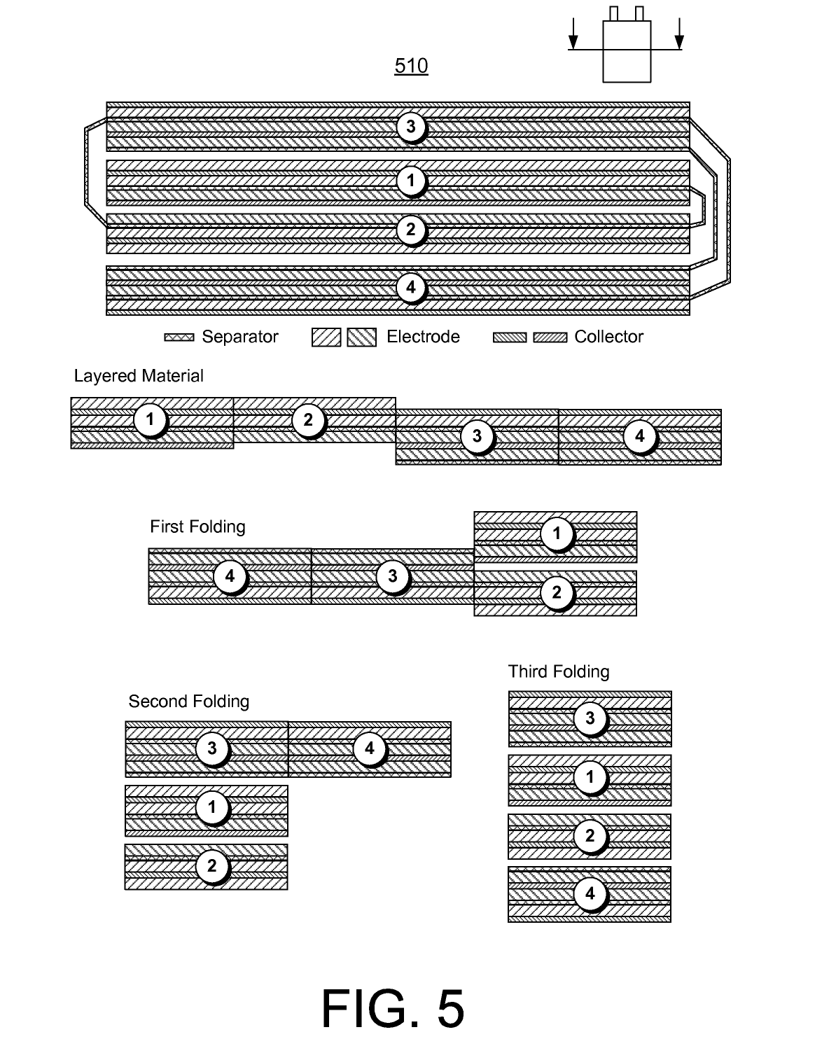

FIG. 5 shows an example of a folded stack 510 that may exhibit an increased energy density when compared to the folded stack 410 of FIG. 4. As shown in the example of FIG. 5, the folded stack 510 may be formed by providing layered material followed by a first folding, a second folding and a third folding of the layered material (e.g., folding in a clockwise direction). As shown, the layered material may include different layers over a span of the layered material, for example, while including at least one continuous (e.g., contiguous) layer of material. In such an example, at least one continuous layer of material may be a continuous layer of separator material.

In FIG. 5, spaces between portions labeled 1, 2, 3 and 4 are provided for purposes of illustration as, for example, such portions may be in contact to form a stack of cells of a lithium-ion battery. In the example of FIG. 5, the layers of the stack 510 may be considered to be active layers in that each of the layers can participate in battery function. In other words, the stack 510 may lack inactive layers, which may act to increase stack height and thereby decrease energy density of the stack.

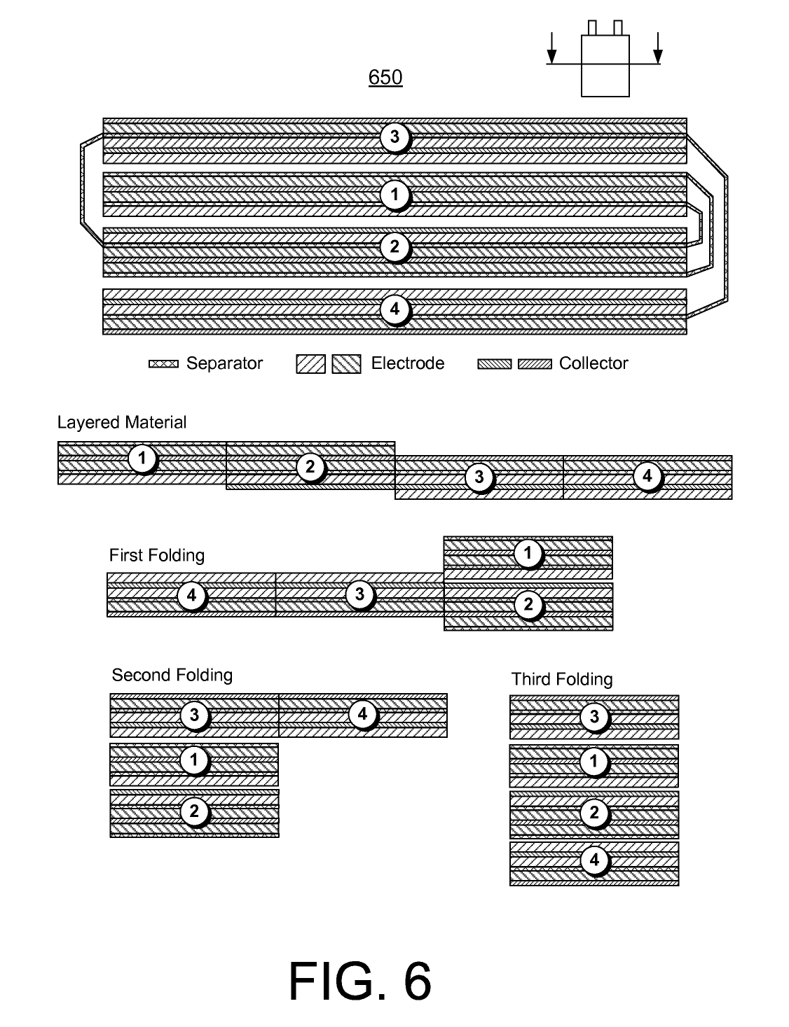

FIG. 6 shows an example of a folded stack 650 that may exhibit an increased energy density when compared to the folded stack 450 of FIG. 4. As shown in the example of FIG. 6, the folded stack 650 may be formed by providing layered material followed by a first folding, a second folding and a third folding of the layered material (e.g., folding in a clockwise direction). As shown, the layered material may include different layers over a span of the layered material, for example, while including at least one continuous (e.g., contiguous) layer of material. In such an example, at least one continuous layer of material may be a continuous layer of separator material.

In FIG. 6, spaces between portions labeled 1, 2, 3 and 4 are provided for purposes of illustration as, for example, such portions may be in contact to form a stack of cells of a lithium-ion battery. In the example of FIG. 6, the layers of the stack 650 may be considered to be active layers in that each of the layers can participate in battery function. In other words, the stack 650 may lack inactive layers, which may act to increase stack height and thereby decrease energy density of the stack.

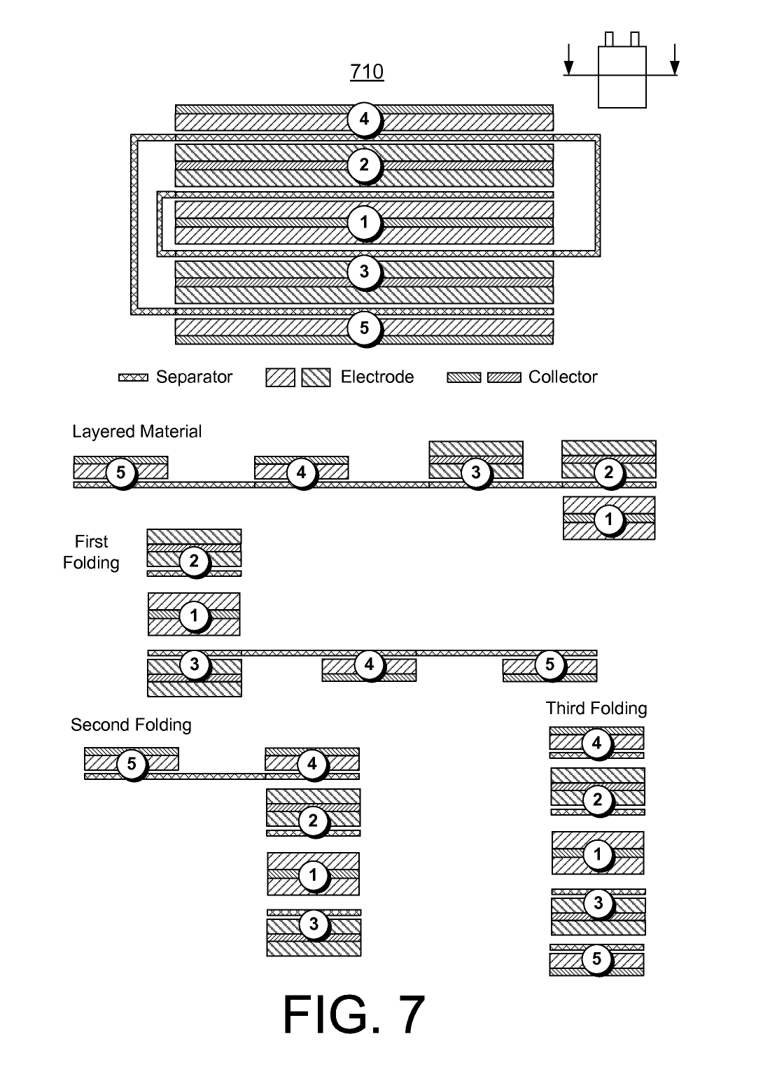

FIG. 7 shows an example of a folded stack 710 that may exhibit an increased energy density. As shown in the example of FIG. 7, the folded stack 710 may be formed by providing layered material followed by a first folding, a second folding and a third folding of the layered material (e.g., folding in a counterclockwise direction). As shown, the layered material may include different layers over a span of the layered material, for example, while including at least one continuous (e.g., contiguous) layer of material. In such an example, at least one continuous layer of material may be a continuous layer of separator material.

In FIG. 7, spaces between portions labeled 1, 2, 3, 4 and 5 are provided for purposes of illustration as, for example, such portions may be in contact to form a stack of cells of a lithium-ion battery. In the example of FIG. 7, the layers of the stack 710 may be considered to be active layers in that each of the layers can participate in battery function. In other words, the stack 710 may lack inactive layers, which may act to increase stack height and thereby decrease energy density of the stack.

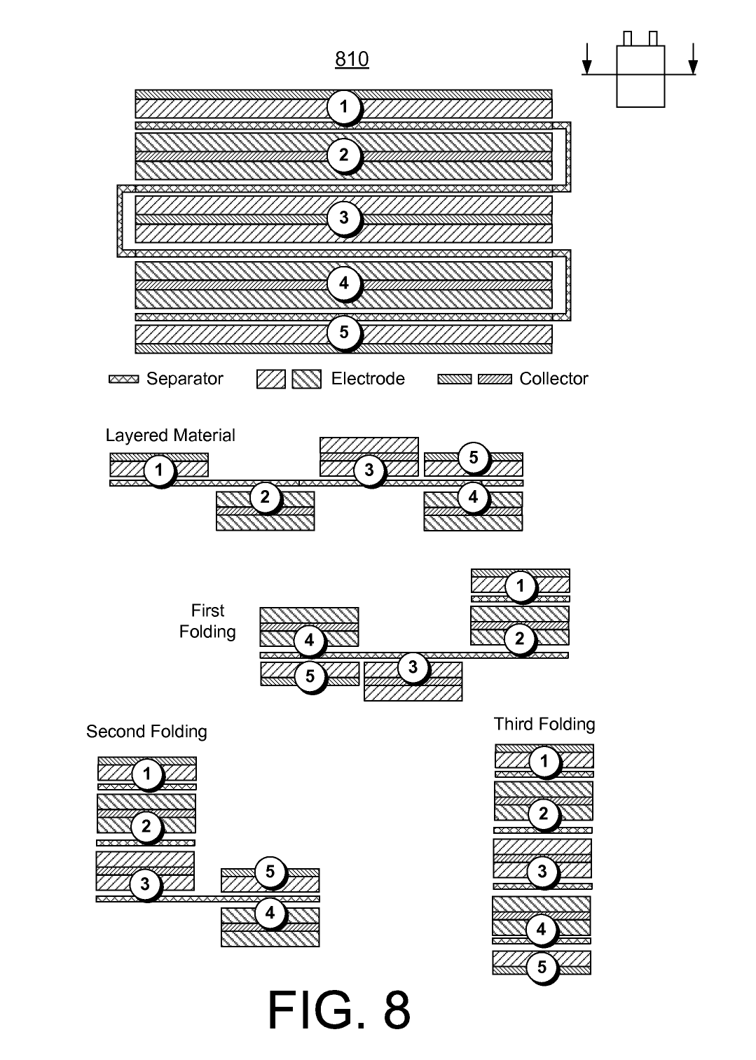

FIG. 8 shows an example of a folded stack 810 that may exhibit an increased energy density. As shown in the example of FIG. 8, the folded stack 810 may be formed by providing layered material followed by a first folding, a second folding and a third folding of the layered material (e.g., folding in a zigzag manner). As shown, the layered material may include different layers over a span of the layered material, for example, while including at least one continuous (e.g., contiguous) layer of material. In such an example, at least one continuous layer of material may be a continuous layer of separator material.

In FIG. 8, spaces between portions labeled 1, 2, 3, 4 and 5 are provided for purposes of illustration as, for example, such portions may be in contact to form a stack of cells of a lithium-ion battery. In the example of FIG. 8, the layers of the stack 810 may be considered to be active layers in that each of the layers can participate in battery function. In other words, the stack 810 may lack inactive layers, which may act to increase stack height and thereby decrease energy density of the stack.

As an example, a method can include providing a sheet of lithium-ion conductive separator material that carries anode electrode material, cathode electrode material, anode collector material and cathode collector material; folding the sheet to form a rectangular stack where, in the rectangular stack, the folded sheet separates anode electrode material and cathode electrode material; and forming a lithium-ion battery from the rectangular stack where opposing outer layers of the rectangular stack may be anode collector material and/or cathode collector material.

As an example, the stack 510 of FIG. 5 may be formed by providing a sheet of separator material that carries layers of material and folding the sheet to form the stack 510, the stack 650 of FIG. 6 may be formed by providing a sheet of separator material that carries layers of material and folding the sheet to form the stack 650, the stack 710 of FIG. 7 may be formed by providing a sheet of separator material that carries layers of material and folding the sheet to form the stack 710, and the stack 810 of FIG. 8 may be formed by providing a sheet of separator material that carries layers of material and folding the sheet to form the stack 810.

Depending on the type of folding, various layers of material may be spaced along a sheet of material, disposed on one side of a sheet of material, disposed on another side of a sheet of material, etc. Some examples may be understood with respect to the example stacks 310, 320, 510, 650, 710 and 810. For example, FIG. 7 shows spacing between various layers of material. As an example, spaces may account for a number of folds, types of folding (e.g., rolling, zigzag, etc.), etc.

As an example, a method may include structuring a stack of cells to reduce inactive material to increase energy density of the stack of cells. As an example, a method may include forming a rectangular stack of cells by folding in a clockwise orientation, a counterclockwise orientation or a zigzag orientation of layers of material. As an example, such a method may include folding where a starting portion (e.g., an inner portion) and/or an ending portion (e.g., an outer portion) of layered material have a half electrode configuration (e.g., a layer of collector material and an adjacent layer of electrode material). In such an example, a starting portion and/or an ending portion half electrode may be carried by separator material, which may optionally be a continuous layer of separator material.

As an example, a stack of cells may include 7 full electrodes (e.g., four cathode and three anode) to form 6 cells in a rectangular configuration with a length of about 50 mm and a width of about 40 mm such that a total cathode electrode surface area is about 22,000 mm² (with about 3,700 mm² or about 17% being inactive). In such an example, removal of a layer of cathode electrode material to form a half electrode from an outer full cathode electrode and addition of a half anode electrode adjacent to another outer full cathode electrode (e.g., with a layer of separator material disposed therebetween) may provide a modified stack of cells with an increased energy density. As an example, a stack of 6 cells with 7 full electrodes may have a rectangular configuration with a length of about 100 mm and a width of about 20 mm with about 17% inactive electrode surface area. A reconfiguration of such a stack a cells may reduce the inactive electrode surface area through use of one or more half electrodes to produce a stack of cells with an increased energy density. Where a stack of 3 cells is considered, as being formed by 4 full electrodes, inactive electrode surface area may be about 33% for cathode or anode electrode material (e.g., depending on which are positions as outer full electrodes in the stack). A reconfiguration of such a stack a cells may reduce the inactive electrode surface area through use of one or more half electrodes to produce a stack of cells with an increased energy density.

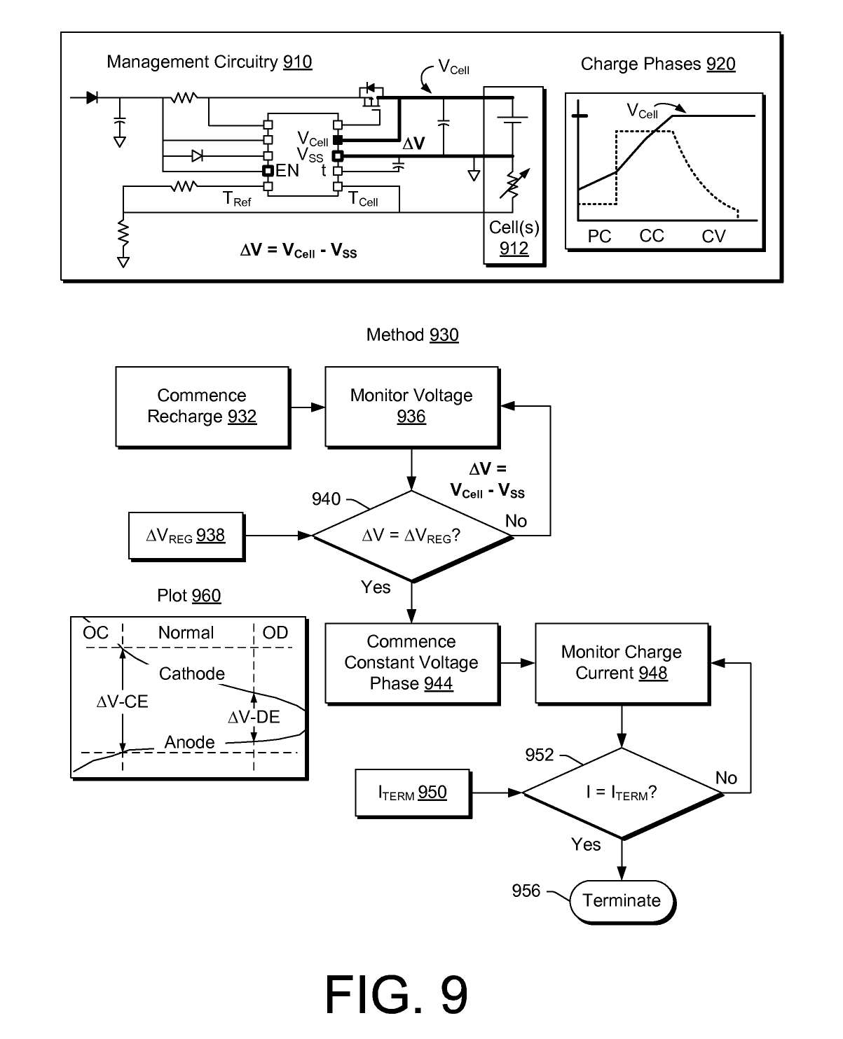

FIG. 9 shows an example of management circuitry 910 for managing charging of one or more electrochemical cells 912, an example charge phase plot 920, an example of a method 930 and an example potential plot 960.

As shown in FIG. 9, management circuitry 910 includes an integrated circuit with 10 pins. The pins may include charge current sense input, battery management input supply, charge status output, logic enable, cell temperature sensor bias, cell temperature sensor input, timer set, cell management 0 V reference, cell voltage sense, and drive output. As to protection features, a cell temperature sensor bias feature may provide for a voltage reference to bias an external thermistor for continuous cell temperature monitoring and prequalification while a cell temperature sensor input feature may provide for input for an external thermistor for continuous cell temperature monitoring and prequalification (optionally may be disabled by applying a set voltage) and safety timers (e.g., preconditioning, fast charge, elapsed time termination, etc.) that may be scaled by a capacitor. A temperature-sensing circuit may have its own reference such that it is immune to fluctuations in the supply voltage input (e.g., where the temperature-sensing circuit is removed from the system when no supply is applied, eliminating additional discharge of cell(s)).

As to logic, a logic enable feature may provide for input that, for example, forces charge termination, initiates charge, clears faults or disables automatic recharge. For example, a logic-enable input pin (EN) may provide for features to terminate a charge anytime during the charge cycle, initiate a charge cycle or initiate a recharge cycle. A logic input (e.g., high or low) may signal termination of a charge cycle.

Also shown in FIG. 9 is an example of a charge phase plot 920 that indicates, as an example, how charging may include a preconditioning phase (PC), a constant current phase (CC) and a constant voltage (CV) phase.

A cell voltage sense function (e.g., implemented in part via the pin labeled “V_{Cell}”) can provide for monitoring voltage at, for example, a positive terminal of a cell (e.g., for single, dual, etc., series cell packs with coke or graphite anodes) with respect to a reference that is based on the negative terminal of a cell (see, e.g., the pin labeled V_{SS}). Thus, the management circuitry 910 can measure voltage (e.g., ΔV) as a difference between a cathode potential (V_{cathode}, as applied at the pin V_{Cell}) and an anode potential (V_{anode}, as applied at the pin V_{SS}). As explained with respect to the method 930, a specified voltage (ΔV_{REG}) may be a limit for ΔV. In the example of FIG. 9, the management circuitry 910 and the method 930 do not include a mechanism for adjusting ΔV_{REG} or adjusting measurements of V_{Cell} or ΔV if the anode potential (V_{anode}) as applied to the pin V_{SS} should change. For example, if the anode potential (V_{anode}) applied to the pin V_{SS} increases then the cathode potential (V_{cathode}) applied to the pin V_{Cell} required to commence the constant voltage (CV) phase may be increased as well, possibly to a potential that exceeds an upper limit for the cathode.

Management circuitry may be configured to manage, to varying extent, state-of-charge (SOC) mismatch and capacity/energy (C/E); noting that as the number of cells and load currents increase, the potential for mismatch also increases. Though SOC may be more common, each type of mismatch problem may limit capacity (mA·h) of a pack of cells to capacity of the weakest cell.

In the example of FIG. 9, the cell(s) 912 may include a polymer composite material such as polyethylene oxide (PEO), polyacrylonitrile, etc. that includes lithium salt. Such a cell or cells may be referred to as a lithium-ion battery or a lithium-ion polymer battery or a lithium-polymer battery (e.g., “LiPo battery” or “LiPo cell”). LiPo cells are sometimes referred to as laminate cells, which may be configured very thin or quite large depending on their intended use. One or more LiPo cells may be encased in a flexible aluminum foil laminate pouch (e.g., with a thickness of the order of about 0.1 mm; see, e.g., the casing 110 of the battery 100 of FIG. 1). LiPo cells may include a stacked construction formed by stacking materials that include electrode and electrolyte materials in a flat sandwich (e.g., defined by length, width and height dimensions). Stacked layers may be packed in a package (see, e.g., the casing 110 of FIG. 1) in a flat, rolled or other configuration. LiPo cell capacities may include capacities in a range, for example of about 50 mA·hrs (e.g., for a small cell such as for a Bluetooth headset) to about 10 A·hrs or more for an electric vehicle (e.g., electric or hybrid).

As to function of a lithium-ion cell, lithium ions move from a negative electrode (e.g., anode) to a positive electrode (e.g., cathode) during discharge and reversely when being charged. As an example, a LiPo cell can include a polyethylene (PE), a polypropylene (PP), a PP/PE, or other material as a separator material. Some LiPo cells may include a polymer gel containing an electrolyte solution, which may be, for example, coated onto an electrode surface (e.g., as a separator material layer). As an example, a continuous layer of material may be provided that carries various materials where the continuous material may be folded to form a stack of materials. As an example, the continuous layer of material may be a separator material in that portions of it are disposed between layers of electrode materials (e.g., to separator anode electrode material from cathode electrode material).

For lithium-ion cells, when cell voltage drops to a low value (e.g., about 1.5 V), reactions at an anode can produce gas (e.g., over-discharge or “OD”). If voltage continues to drop (e.g., under about 1 V), copper of a copper-based anode current collector can start to dissolve and may short out a cell. When cell voltage increases to a high value (e.g., about 4.6 V), gassing may occur at a cathode as electrolyte may start to decompose (e.g., overcharge or “OC”). As an example, a lithium-ion cell or cells may be connected to an external thermal fuse for overcharge protection (e.g., in addition to the control by management circuitry). As to the potential plot 960, it shows a normal operating range that exists between a charge end voltage (ΔV-CE) and a discharge end voltage (ΔV-DE). In the example of FIG. 9, the normal range lies between an overcharge region (0C) and an over-discharge region (OD). As mentioned, damage can occur in either of these regions.

As to the example method 930 of FIG. 9, it pertains to recharging one or more lithium-ion cells such as the cell(s) 912, for example, using circuitry such as the management circuitry 910 and achieving charge phases such as those of the charge phase plot 920.

As shown in FIG. 9, the method 930 commences in a commencement block 932 for commencing a recharge of one or more cells. The commencement block 932 can initiate a preconditioning (PC) phase and, thereafter, a constant current (CC) phase. A monitor block 936 follows for monitoring voltage of the one or more cells during a constant current (CC) phase. A decision block 940 relies on monitoring of the voltage for comparison to a specified voltage (ΔV_{REG}). The decision block 940 provides for deciding when the recharge process should terminate the constant current (CC) phase and commence a constant voltage (CV) phase.

The decision block 940 may receive a value for the specified voltage (ΔV_{REG}) from one or more storage registers 938 for storing one or more values for the specified voltage (ΔV_{REG}). In the example of FIG. 9, the one or more storage registers 938 may store a value such as 4.1 V, 4.2 V, 8.2 V, 8.4 V, etc. (e.g., as one or more preset voltage regulation options). The value or values stored in the one or more storage registers 938 may depend on characteristics of a cell or cells or number of cells. In the example of FIG. 9, the specified value (ΔV_{REG}) may be based on the maximum voltage that a particular lithium-ion cell (or cells) can reach during charging as to prevent overcharge side reactions at a positive electrode and material phase changes in a positive electrode. As some examples, consider a LiCoO₂ cathode material with a maximum operational potential of about 4.2 V and a LiMnO₄ cathode material with a maximum operational potential of about 4.3 V.

In the example of FIG. 9, the management circuitry 910 may reference inputs and outputs with respect to a management circuit reference potential (V_{SS}) that may be intended to be a 0 V reference potential. In the circuitry 910, one of the pins, labeled V_{SS}, is electrically connected to the “negative” electrode of the cell(s) 912. Specifically, it is electrically connected with the anode(s) of the cell(s) 912 (e.g., via collector material). Accordingly, in the method 930, the voltage monitored by the monitoring block 936 (e.g., at the pin labeled V_{Cell}) is measured with respect to the negative electrode (i.e., anode(s)) of the cell(s) 912 (e.g., applied to the pin labeled V_{SS}). Such an approach relies on an assumption that the negative electrode (e.g., anode(s)) of the cell(s) 912 (e.g., V_{SS}) has a potential of approximately 0 V and remains at approximately 0 V. Under such an assumption, the condition of the decision block 940 may be met when V_{Cell}−V_{SS}=ΔV_{REG}. However, should changes occur to the cell(s) 912, the potential of the anode may not remain constant. For example, if the potential of the anode increases, then the potential at the pin labeled V_{SS} of the management circuitry 910 will increase as well. Under such conditions, to meet the criterion specified by ΔV_{REG}, the potential of the cathode must be higher as applied to the pin labeled V_{Cell} of the management circuitry 910. Depending on the amount of increase in potential of the anode, the potential of the cathode may exceed a recommended upper limit for the cathode.

As shown in the example of FIG. 9, the method 930 continues to the commencement block 944 for commencing a constant voltage (CV) phase when the decision block 940 decides that the monitored voltage (e.g., ΔV=V_{Cell}−V_{SS}) is equal to the specified voltage (e.g., ΔV_{REG}).

For the constant voltage (CV) phase, the method 930 continues in a monitor block 948 for monitoring charge current, which may decline with respect to time as shown in the charge phase plot 920. As shown, another decision block 952 provides for deciding when the constant voltage (CV) phase should terminate. For example, a storage register 950 may store a value for a termination current I_{TERM}. In such an example, the decision block 952 may receive the I_{TERM} value from the storage register 950 and compare it to a monitored current value from the monitor block 948. As the monitored current diminishes during the constant voltage (CV) phase, it eventually reaches the I_{TERM} value, upon which the method 930 terminates in a termination block 956 (e.g., to terminate the recharge process commenced at block 932).

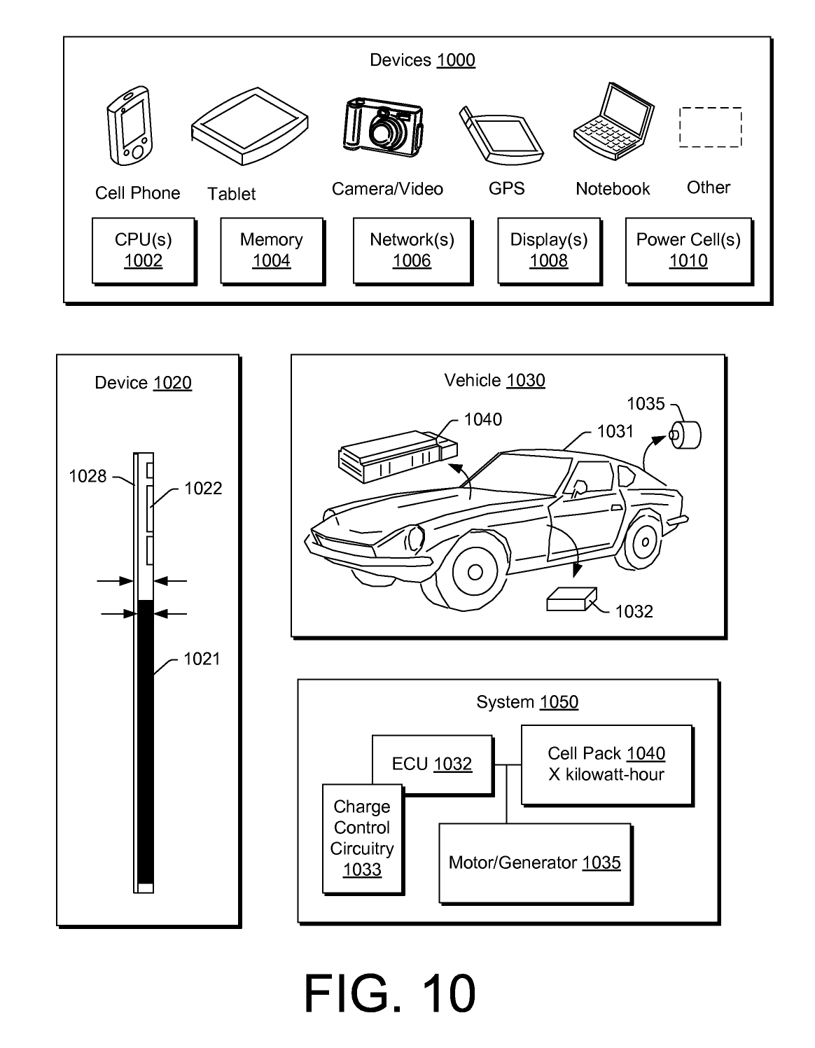

FIG. 10 shows some examples of devices 1000 that may be powered by a lithium-ion cell or cells (e.g., in the form of a lithium-ion battery or batteries). For example, a cell phone, a tablet, a camera, a GPS device, a notebook computer, or other device may be powered by a lithium-ion cell or cells. As to other devices, a device may be an electric motor of an electric vehicle or a hybrid vehicle. A device may be an automobile, a toy, a remote control device (e.g., a bomb sniffers, drones, etc.), etc. A device may include one or more processors 1002, memory 1004, one or more network interfaces 1006, one or more displays 1008 and, as a power source, one or more lithium-ion cells 1010.

As an example, a device 1020 may include a power cell(s) 1021, circuitry 1022 and, for example, a display 1028. In such an example, the thickness of the device 1020 may be determined largely by a thickness of the power cell(s) 1021. For example, about 80 percent of the overall thickness of the device 1020 may be determined by a thickness of the power cell(s) 1021. As an example, the power cell(s) 1021 may be formed via folding of layered material, for example, to achieve a desired ED (see, e.g., the example stacks 310, 320, 510, 650, 710 and 810).

FIG. 10 also shows an example of a vehicle 1030 that includes an engine control unit (ECU) 1032, a cell pack 1040 and an electric motor and generator 1035 and an example of a system 1050 for the vehicle 1030 that includes the ECU 1032, the cell pack 1040, the electric motor and generator 1035 and charge control circuitry 1033 (e.g., which may be part of the ECU 1032). The vehicle 1030 may include, for example, one or more processors, memory, etc.

As an example, the vehicle 1030 may be a hybrid electric vehicle (HEV) where the cell pack 1040 is rated at about 1.4 kWh, for example, to absorb braking energy for immediate re-use in an acceleration cycle (e.g., using the electric motor and generator 1035 as a generator in a regenerative braking scheme). As an example, the vehicle 1030 may be a plug-in hybrid electric vehicle (PHEV) where the cell pack 1040 is rated at about 5.2 to 16 kWh, for example, to offer both hybrid and electric drive functions. As an example, the vehicle 1030 may be a battery electric vehicle (BEV) where the cell pack 1040 is rated at about 24 to 85 kWh to propel the vehicle 1030.

As an example, the cell pack 1040 may be formed in part by folding layered material, for example, to achieve a desired ED (see, e.g., the example stacks 310, 320, 510, 650, 710 and 810).

As an example, a system can include a lithium-ion battery that includes anode electrode material, anode collector material, cathode electrode material, cathode collector material, a full electrode that includes a layer of one of the collector materials disposed between and adjacent to two layers of a corresponding one of the electrode materials, a half electrode that includes a layer of one of the collector materials disposed adjacent to a layer of a corresponding one of the electrode materials, and lithium-ion conductive separator material folded to align the full electrode and the half electrode and disposed between one of the two layers of the electrode material of the full electrode and the layer of the electrode material of the half electrode; and system components where one or more of the system components is operatively coupled to the lithium-ion battery for receipt of power. As an example, such a system may be an information handling system where the system components include a processor and memory (e.g., and optionally a display). As an example, an information handling system maybe a computing device that includes a display such as, for example, a tablet, a notebook, a smart phone, etc. (e.g., or one or more combinations thereof). As an example, a system may be a vehicle where system components include an electric motor operatively coupled to a drivetrain and a vehicle control unit.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory card, a storage disk, etc.) and referred to as a computer-readable storage medium. As an example, a computer-readable medium may be a computer-readable medium that is not a carrier wave.

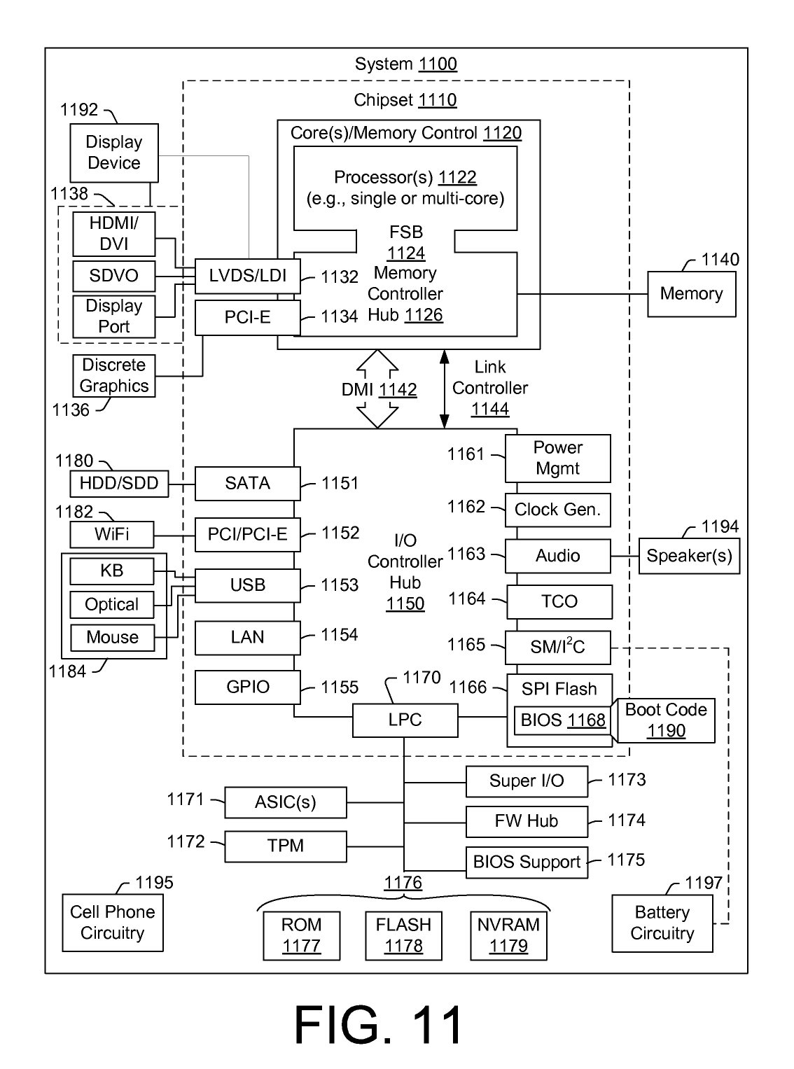

While various examples of circuits or circuitry have been discussed, FIG. 11 depicts a block diagram of an illustrative computer system 1100. The system 1100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 1100. As described herein, a device such as one of the devices 1000 of FIG. 10 may include at least some of the features of the system 1100.

As shown in FIG. 11, the system 1100 includes a so-called chipset 1110. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 11, the chipset 1110 has a particular architecture, which may vary to some extent depending on brand or manufacturer. The architecture of the chipset 1110 includes a core and memory control group 1120 and an I/O controller hub 1150 that exchange information (e.g., data, signals, commands, etc.) via, for example, a direct management interface or direct media interface (DMI) 1142 or a link controller 1144. In the example of FIG. 11, the DMI 1142 is a chip-to-chip interface (sometimes referred to as being a link between a “northbridge” and a “southbridge”).

The core and memory control group 1120 include one or more processors 1122 (e.g., single core or multi-core) and a memory controller hub 1126 that exchange information via a front side bus (FSB) 1124. As described herein, various components of the core and memory control group 1120 may be integrated onto a single processor die, for example, to make a chip that supplants the conventional “northbridge” style architecture.

The memory controller hub 1126 interfaces with memory 1140. For example, the memory controller hub 1126 may provide support for DDR SDRAM memory (e.g., DDR, DDR2, DDR3, etc.). In general, the memory 1140 is a type of random-access memory (RAM). It is often referred to as “system memory”.

The memory controller hub 1126 further includes a low-voltage differential signaling interface (LVDS) 1132. The LVDS 1132 may be a so-called LVDS Display Interface (LDI) for support of a display device 1192 (e.g., a CRT, a flat panel, a projector, etc.). A block 1138 includes some examples of technologies that may be supported via the LVDS interface 1132 (e.g., serial digital video, HDMI/DVI, display port). The memory controller hub 1126 also includes one or more PCI-express interfaces (PCI-E) 1134, for example, for support of discrete graphics 1136. Discrete graphics using a PCI-E interface has become an alternative approach to an accelerated graphics port (AGP). For example, the memory controller hub 1126 may include a 16-lane (×16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1150 includes a variety of interfaces. The example of FIG. 11 includes a SATA interface 1151, one or more PCI-E interfaces 1152 (optionally one or more legacy PCI interfaces), one or more USB interfaces 1153, a LAN interface 1154 (more generally a network interface), a general purpose I/O interface (GPIO) 1155, a low-pin count (LPC) interface 1170, a power management interface 1161, a clock generator interface 1162, an audio interface 1163 (e.g., for speakers 1194), a total cost of operation (TCO) interface 1164, a system management bus interface (e.g., a multi-master serial computer bus interface) 1165, and a serial peripheral flash memory/controller interface (SPI Flash) 1166, which, in the example of FIG. 11, includes BIOS 1168 and boot code 1190. With respect to network connections, the I/O hub controller 1150 may include integrated gigabit Ethernet controller lines multiplexed with a PCI-E interface port. Other network features may operate independent of a PCI-E interface.

The interfaces of the I/O hub controller 1150 provide for communication with various devices, networks, etc. For example, the SATA interface 1151 provides for reading, writing or reading and writing information on one or more drives 1180 such as HDDs, SDDs or a combination thereof. The I/O hub controller 1150 may also include an advanced host controller interface (AHCI) to support one or more drives 1180. The PCI-E interface 1152 allows for wireless connections 1182 to devices, networks, etc. The USB interface 1153 provides for input devices 1184 such as keyboards (KB), one or more optical sensors, mice and various other devices (e.g., microphones, cameras, phones, storage, media players, etc.). On or more other types of sensors may optionally rely on the USB interface 1153 or another interface (e.g., I²C, etc.). As to microphones, the system 1100 of FIG. 11 may include hardware (e.g., audio card) appropriately configured for receipt of sound (e.g., user voice, ambient sound, etc.).

In the example of FIG. 11, the LPC interface 1170 provides for use of one or more ASICs 1171, a trusted platform module (TPM) 1172, a super I/O 1173, a firmware hub 1174, BIOS support 1175 as well as various types of memory 1176 such as ROM 1177, Flash 1178, and non-volatile RAM (NVRAM) 1179. With respect to the TPM 1172, this module may be in the form of a chip that can be used to authenticate software and hardware devices. For example, a TPM may be capable of performing platform authentication and may be used to verify that a system seeking access is the expected system.

The system 1100, upon power on, may be configured to execute boot code 1190 for the BIOS 1168, as stored within the SPI Flash 1166, and thereafter processes data under the control of one or more operating systems and application software (e.g., stored in system memory 1140). An operating system may be stored in any of a variety of locations and accessed, for example, according to instructions of the BIOS 1168. Again, as described herein, a satellite, a base, a server or other machine may include fewer or more features than shown in the system 1100 of FIG. 11. Further, the system 1100 of FIG. 11 is shown as optionally include cell phone circuitry 1195, which may include GSM, CDMA, etc., types of circuitry configured for coordinated operation with one or more of the other features of the system 1100. Also shown in FIG. 11 is battery circuitry 1197, which may provide one or more battery, power, etc., associated features (e.g., optionally to instruct one or more other components of the system 1100). As an example, a SMBus may be operable via a LPC (see, e.g., the LPC interface 1170), via an I²C interface (see, e.g., the SM/I²C interface 1165), etc.

### CONCLUSION

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A lithium-ion battery comprising:
anode electrode material;
anode collector material;
cathode electrode material;
cathode collector material;
a full electrode that comprises a layer of one of the collector materials disposed between and adjacent to two layers of a corresponding one of the electrode materials;
a half electrode that comprises a layer of one of the collector materials disposed adjacent to a layer of a corresponding one of the electrode materials; and
lithium-ion conductive separator material folded to align the full electrode and the half electrode and disposed between one of the two layers of the electrode material of the full electrode and the layer of the electrode material of the half electrode.

2. The lithium-ion battery of claim 1 comprising foil packaging material.

3. The lithium-ion battery of claim 1 wherein the lithium-ion conductive separator material is folded to form a stack.

4. The lithium-ion battery of claim 3 wherein the stack comprises a rectangular roll having a clockwise orientation or a counterclockwise orientation.

5. The lithium-ion battery of claim 3 wherein the stack comprises a rectangular accordion stack having a zigzag orientation.

6. The lithium-ion battery of claim 1 wherein the full electrode and the half electrode are attached to the lithium-ion conductive separator material.

7. The lithium-ion battery of claim 1 wherein the materials comprise planar materials.

8. The lithium-ion battery of claim 1 comprising two half electrodes.

9. The lithium-ion battery of claim 8 wherein the two half electrodes comprise anode electrode material.

10. The lithium-ion battery of claim 8 wherein the two half electrodes comprise cathode electrode material.

11. The lithium-ion battery of claim 8 wherein one of the two half electrodes comprises anode electrode material and wherein the other of the two half electrodes comprises cathode electrode material.

12. The lithium-ion battery of claim 1 wherein layers of the anode electrode material are active electrode layers and wherein layers of the cathode electrode material are active electrode layers.

13. The lithium-ion battery of claim 1 comprising only active electrode layers.

14. The lithium-ion battery of claim 1 wherein an outer layer comprises collector material.

15. The lithium-ion battery of claim 1 comprising an outer layer that comprises anode collector material and an outer layer that comprises cathode collector material.

16. A system comprising:
a lithium-ion battery that comprises anode electrode material, anode collector material, cathode electrode material, cathode collector material, a full electrode that comprises a layer of one of the collector materials disposed between and adjacent to two layers of a corresponding one of the electrode materials, a half electrode that comprises a layer of one of the collector materials disposed adjacent to a layer of a corresponding one of the electrode materials, and lithium-ion conductive separator material folded to align the full electrode and the half electrode and disposed between one of the two layers of the electrode material of the full electrode and the layer of the electrode material of the half electrode;
system components wherein one or more of the system components is operatively coupled to the lithium-ion battery.

17. The system of claim 16 wherein the system is an information handling system and wherein the system components comprise a processor and memory.

18. The system of claim 17 wherein the information handling system is a computing device that comprises a display.

19. The system of claim 16 wherein the system is a vehicle and wherein the system components comprise an electric motor operatively coupled to a drivetrain and a vehicle control unit.

20. A method comprising:
providing a sheet of lithium-ion conductive separator material that carries anode electrode material, cathode electrode material, anode collector material and cathode collector material;
folding the sheet to form a rectangular stack wherein, in the rectangular stack, the folded sheet separates anode electrode material and cathode electrode material; and
forming a lithium-ion battery from the rectangular stack wherein opposing outer layers of the rectangular stack comprise a member selected from a group consisting of anode collector material and cathode collector material.
